(19) United States
(12) Patent Application Publication
(10) Pub. No.: US 2006/0291523 A1
(43) Pub. Date: Dec. 28, 2006

(54) Fluid-cooled duct

(76) Inventor: Robert Johnson, Austin, AR (US)

Correspondence Address: Kyla D. Cummings;SPEED LAW FIRM, Suite 1200, 111 Center Street, Little Rock, AR, 72201, US

(21) Appl. No.: 11/418,792

(22) Filed: May 5, 2006

Related U.S. Application Data
(60) Provisional application No. 60/679,533, filed on May 10, 2005.

(51) Int. Cl. F27D 1/12

(52) U.S. Cl. 373/76

(57) ABSTRACT

Embodiments include a method and apparatus for cooling effluent flowing through a fluid-cooled duct. The apparatus comprises a base material having a bore therethrough through which effluent is flowable, and channel members and bar members operatively connected to the base material to form fluid flow paths around the outer surface of the base material for cooling fluid flow. Embodiments of the method include flowing cooling fluid from the first fluid flow path into the second fluid flow path and allowing heat transfer from the effluent to the fluid via the base material. Embodiments further include a method of forming the fluid-cooled duct.

### CROSS-REFERENCE TO RELATED APPLICATIONS

This application claims benefit of U.S. Provisional Patent Application Ser. No. 60/679,533, filed May 10, 2005, which is herein incorporated by reference in its entirety.

### BACKGROUND OF THE INVENTION

1. Field of the Invention

Embodiments of the present invention generally relate to a fluid-cooled duct. More specifically, embodiments of the present invention generally relate to a water-cooled duct for use in a steel mill.

2. Description of the Related Art

Water-cooled ducts are utilized in the steel manufacturing process in conjunction with various pieces of equipment. Generally, water-cooled ducts operate as a cooling medium for processes performed and components located within a steel mill, including basic oxygen furnace components, electric arc furnace components, ladle arc furnace components, sidewall panels, and basic oxygen steel-making off-gas systems.

Specifically, a water-cooled duct is connected to a steel mill so that hot fumes coming from one or more furnaces of a steel mill are forced through the duct rather than into the atmosphere. Currently utilized water-cooled duct designs are intended for two purposes: (1) to allow a dropout-type duct so that larger material not carried to the baghouse may be collected in a dropout area, and (2) to control combustion air entry into the duct for carbon dioxide burn-off.

The hot fumes coming from the furnaces may reach temperatures of approximately 8000-9000° F. and upwards. Water flow around the water-cooled duct is employed to cool these hot fumes and prevent the hot fumes from melting the water-cooled duct as the fumes flow away from the furnace through the duct.

Typical water-cooled ducts possess several disadvantages. In constructing a typical water-cooled duct, a multi-piece tube system is used in which pipes are welded together side-by-side to form the duct. At or near the location where the pipes are welded together (the void spot), the typical water-cooled duct is vulnerable to experiencing abrasion and/or corrosion due to the weakening of the pipes at the void spots. Over time, the pipes at or near the welded locations may fail, causing water or other substances within the water-cooled duct to disadvantageously leak from the pipes and/or causing effluent to leak into the pipes. Leaking of the water or other substances from the duct and of the effluent into the pipes causes safety concerns and increases the cost of an operation due to the cost to repair the duct, the additional attention required for repair of the multi-piece duct by maintenance personnel, and the down-time of the steel-making operation while maintenance personnel are fixing the duct (as the repair requires shutting down the system).

FIG. 1 shows a plan view of a typical water-cooled duct 30 for use with an electric arc furnace (not shown), and FIG. 1A shows a cross-sectional view of the water-cooled duct 30 along line A-A of FIG. 1. As shown in FIG. 1A, the water-cooled duct 30 is constructed by welding multiple pipes 31 together. All of the pipes 31 are welded together along their length at attachment points 32 to form the conduit within the bores 34 of the pipes 31 for water flow W therethrough as well as to form the conduit for effluent flow E from the furnace through a bore 1 of the water-cooled duct 30. In essence, the pipes 31 themselves from the water-cooled duct 30.

To form the water-cooled duct 30, the pipes 31 are welded together at their attachment points 32. These attachment points 32 often form void areas on the pipes 31 where the pipes 31 are structurally weakened due to the weld and where the inside of the pipes 31 are not uniformly shaped so that water flow W through the pipes 31 often causes the pipes 31 to leak or burst and water to exit the pipes 31 at or near those void areas. Furthermore, the bore 1 formed by the surfaces of the pipes 31 is not smooth because of the multiplicity of connected pipes 31, so that the erratic flow of the effluent E around the pipes 31 within the bore 1 may also cause leaks and structural failure of the pipes 31.

FIGS. 2 and 3 demonstrate the encumbered and lengthy process required to repair the pipes 31 when they fail or leak at these void areas or at any other area on the pipe 31. Specifically, FIG. 2 shows a pipe 31B having a structural failure F, along with the adjacent pipes 31A, 31C to the leaking pipe 31B in the piping system (with the pipes 31A, 31B, 3 1C connected to one another at welded attachment points 32). In order to repair the pipe 31B, the water flow through the pipes 31 and the effluent flow through the water-cooled duct 30 must be halted (thereby stopping the operation of the steel mill). A portion must then be cut out of the pipe 31B, as shown in FIG. 3, so that a hole H in the pipe 31B remains exposed. A pipe 36 of the same or similar material, diameter, and shape must then be obtained, and a repair piece R must be cut out of the pipe 36 which is similar to the size and shape of the hole H in the damaged pipe 31B. This repair piece R is then welded to exposed portions of the pipe 31B.

This process employed in repairing the damaged pipe 31B requires expensive shut-down of the steel mill as well as costly customized repair labor and parts. Furthermore, the pipe 31B is likely to fail at a future time in the operation of the water-cooled duct 30 at the welded connection points between the repair piece R and the pipe 31B.

An additional disadvantage of the typical multi-piece duct is that it is extremely complicated to fabricate and requires very specialized components and procedures to connect those components, so that ruptured pipe forming the duct is difficult to repair. Specifically, as shown in FIGS. 1 and 1A, pipe elbows 5 and inlet/outlet flow tubes 4 are required in the typical system to transport the water between the inlet and outlet pipe 25 and the pipes 31. To connect these pipe elbows 5 and inlet/outlet flow tubes 4 to the pipes 31, a specially-formed piece 35 is required. The specially-formed pieces 35 are connected intermittently by welding to adjacent pipes 31 at the inlet/outlet water flow locations.

Because of the large number of welds, the water flowing through the previously-utilized system described above often erodes the weakened locations of the pipes 31 and other specially-formed pieces (for example pieces 35) of the system and therefore causes failures and/or leaks of water or effluent from the water-cooled duct 30. To repair the system at the weld, specially-formed pieces 35 must be constructed, which may take several days, and then the specially-made pieces 35 must be properly welded to the water-cooled duct 30 at the proper location, which may also necessitate days of down-time. (As described above, failure of one or more of the pipes 31 would also require specially-made pieces to repair the pipes 31 and thus would also necessitate possibly days of down-time.)

All in all, several days (often three days or more) of costly down-time are necessary to repair these oft-occurring leaks in the typical water-cooled duct 30 (often costing $1,000-5,000 and upwards per minute of down-time of the system), along with the cost of skilled labor and specialized replacement parts required to repair the system.

Also disadvantageously, the typical water channel system used to cool the water-cooled duct includes a large amount of circuits of the water channel system flowing around the duct. These multi-circuited systems often do not allow the cooling water sufficient time to transfer heat away from the hot face side of the duct. Additionally, the multi-circuited systems often require very high pressure to force the water through the circuiting system.

### SUMMARY OF THE INVENTION

It is therefore an object of embodiments to provide a fluid-cooled duct which is reliable in operation and inexpensive to fabricate and maintain.

It is a further object of embodiments to provide a fluid-cooled duct which minimizes the down-time and cost of repair required to maintain the operation of the duct.

It is yet a further object of embodiments to provide a fluid-cooled duct which is simple to repair and fabricate.

It is a further object of embodiments to provide a fluid-cooled duct which reduces the amount of fluid pressure required to effectively cool the duct and its contents.

It is yet a further object of embodiments to provide a fluid-cooled duct having generally horizontal fluid flow therearound.

It is yet a further object of embodiments to provide a fluid-cooled duct having a fluid channel system which transfers heat from the duct to the fluid sufficiently to cool the effluent efficiently.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a plan view of a typical water-cooled duct.

FIG. 1A is a cross-sectional view through line A-A of FIG. 1.

FIG. 2 is a cross-sectional view through select pipes of the water-cooled duct of FIG. 1, showing a ruptured pipe of the typical system.

FIG. 3 is a cross-sectional view of the pipes of FIG. 2, showing a typical method of repair of the ruptured pipe.

FIG. 4 is a plan view of a portion of a steel mill of embodiments of the present invention.

FIG. 5 is a side view of a first embodiment of a fluid-cooled duct showing fluid flow outlets.

FIG. 6 is a side view of the fluid-cooled duct of FIG. 5 showing fluid flow inlets.

FIG. 7 is a cross-sectional view of the fluid-cooled duct of FIGS. 5 and 6 showing a flow circuit system of the cooling fluid.

FIG. 7A is a sectional view of a portion of the fluid-cooled duct of FIG. 7.

FIG. 8 is a side view of a second embodiment of a fluid-cooled duct.

FIG. 9 is a cross-sectional view through line A-A of FIG. 8.

FIG. 10 is a cross-sectional view through line B-B of FIG. 8.

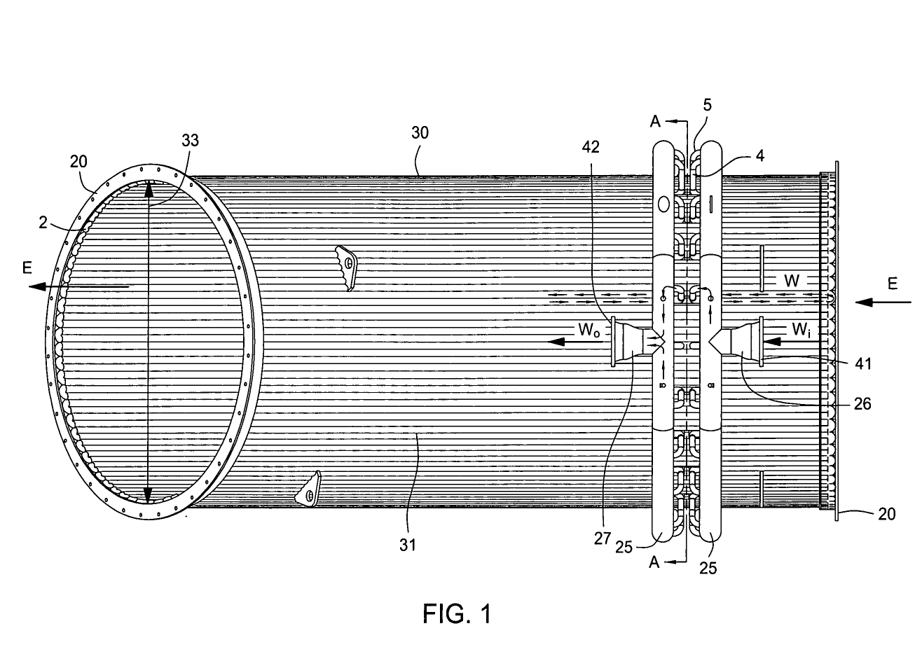

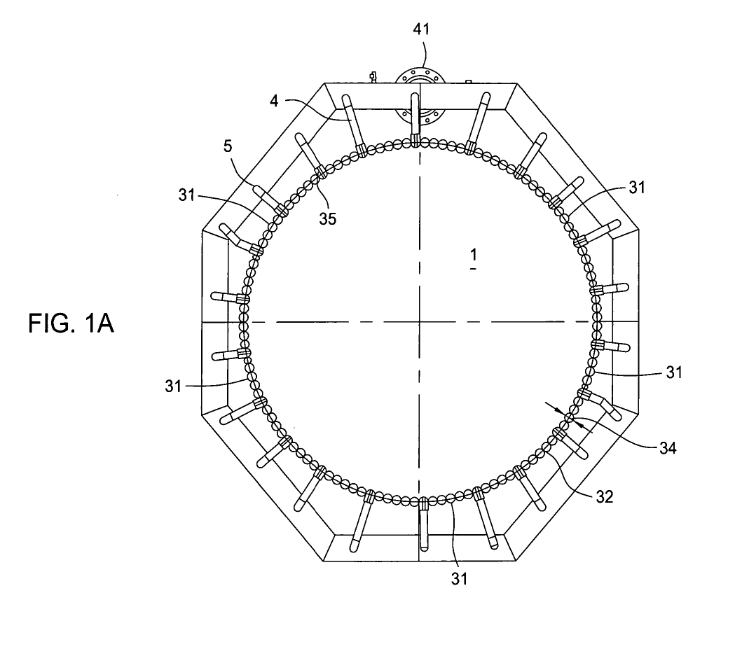

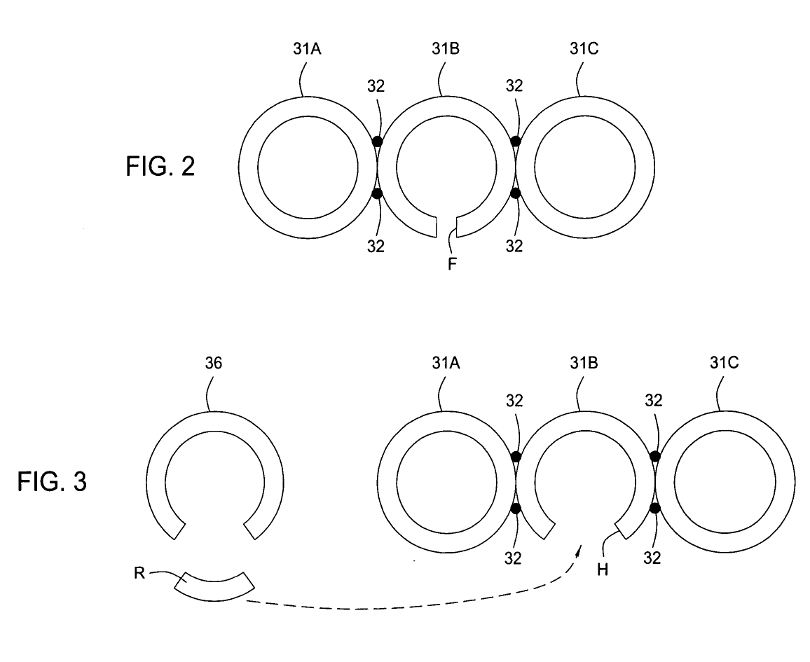

### DETAILED DESCRIPTION

Embodiments include a fluid-cooled duct for a steel mill (where the cooling fluid is preferably, although not necessarily, water). The fluid channel/circuit/flow system and direction of the fluid flow around the duct of embodiments are designed to require the least amount of circuits. Minimizing the amount of circuits of the fluid channel system allows the fluid more time to transfer heat away from the hot face side of the duct and does not require the pressure to force the fluid through the system that multi-circuited systems require. Usually, the flow of the water within the duct is vertical. In the fluid-cooled duct of embodiments of the present invention, the flow of the fluid is generally horizontal. The fluid flows in the direction of the air flow coming from the furnace.

The fluid-cooled duct of embodiments may be constructed from channeled steel which is pinched together.

With the fluid-cooled duct of embodiments, the duct is constructed in one piece. Because of the one-piece design (and/or because of the smooth material used to form the duct), the internal surface of the duct is smooth and without welded pipe joints. The smooth internal surface of the duct of embodiments eliminates the rough internal surface of the typical multi-piece water-cooled duct resulting from the pipes and the welding and thereby allows the fluid to flow smoothly through the duct without the fluid and/or other substances within the duct causing abrasion and/or corrosion of the fluid-cooled duct. Additionally, because of the smooth internal surface, more surface area for fluid and air flow is provided in the duct of embodiments. Also, the one-piece internal surface of the fluid-cooled duct for effluent flow therethrough is more easily fabricated than the previous multi-piece piped duct.

In embodiments, repair of the fluid-cooled duct is facilitated because the damaged portion of a base material forming the inside the fluid-cooled duct is easily replaceable if any repair is necessary. The design of the fluid-cooled duct of embodiments allows a portion of the base material of the fluid-cooled duct to be easily cut out and replaced with a plate or patch. Moreover, repair (and fabrication) of the fluid flow system around the duct is facilitated because the parts which form and define the fluid flow path(s) are easily replaceable and obtainable as standard hardware.

Embodiments preferably ensure dry and complete transfer of effluent materials to the bag house or fume control system and provide an air-tight seal at the joints which prevents the addition of combustion gases into the system. Compliance with these purposes allows the design of the air-cooled duct of embodiments to lessen the wear on the duct from already-existing high temperatures caused by the melting of steel in the furnace and to decrease the length of the duct needed to cool the air down before it reaches the bag house area.

The fluid-cooled duct of embodiments advantageously may be repaired in a short period of time because the inner surface of the duct is at least substantially flat or smooth, thereby allowing patches to be installed in the duct in a short period of time. Because patches can be installed in a short period of time, the cost of the operation is decreased and production of steel over time is increased.

Moreover, the fluid-cooled of embodiments is of a simple construction, allowing for cost-effective fabrication of the duct and easy acquisition of materials for fabrication and/or repair of the duct.

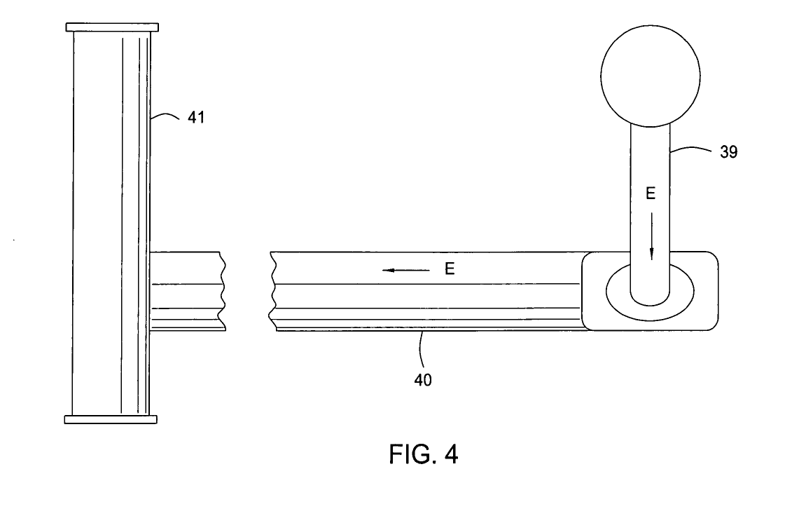

Embodiments of the fluid-cooled duct of the present invention are also described by the drawings, which show different views of embodiments of the fluid-cooled duct and its various components and show the flow pattern of the fluid flow/channel/circuit system of embodiments of the fluid-cooled duct. Specifically, FIG. 4 illustrates a fluid-cooled duct 40 disposed within a portion of a steel mill. FIG. 4 is merely an exemplary arrangement in which the fluid-cooled duct 40 may be utilized; it is contemplated that the fluid-cooled duct 40 may instead or also be employed in any other applications within the steel mill known to those skilled in the art, or in other operations (including non-steel mill applications) known to those skilled in the art in which a fluid-cooled duct may be utilized to cool one or more fluids, such as gas effluent or exhaust, flowing through a duct.

As illustrated in FIG. 4, the fluid-cooled duct 40 is operatively connected at one end to a furnace 39, which may be an electric arc furnace or any other furnace known to those skilled in the art. Effluent E from the furnace 39, which may include one or more gases, flows upward from the furnace into the fluid-cooled duct 40 as shown (and may be “pulled” from the furnace by the air into the fluid-cooled duct 40) so that the fluid-cooled duct 40 operates to transport the effluent E to other portions of the steel mill system and to cool the effluent E to the desired temperature prior to its entrance into other portions of the steel mill system. The fluid cooling the duct 40 prevents the extreme high temperature of the effluent E, which temperature often rises as high as 1500° F. (and may ultimately reach an even higher temperature), upon its exit from the furnace 39, from melting the duct 40 while the effluent E is flowing therethrough.

Although not shown in FIG. 4, an additional duct (which is or is not fluid-cooled) may optionally be connected to either exposed end of the fluid-cooled duct 40 if additional length is needed to transport the effluent E to the next portion of the steel mill. As shown, the next portion of the steel mill may include a baghouse system 41 for filtering certain materials from the effluent E using one or more baghouse filters (not shown), as often required by federal or local environmental laws. For example (although not limiting to the scope of embodiments), the fluid-cooled duct 40 may span approximately 100-200 feet in length, while one or more additional ducts may span approximately 300 feet in length. Over the course of the flow of the effluent E from the furnace 39 to the next portion of the steel mill through the fluid-cooled duct 40, the temperature of the effluent E may decrease, for example (again not limiting to the scope of embodiments), from approximately 1500° F. at or near the exit of the effluent E from the furnace 39 to approximately 350-400° F. at or near the exit of the effluent E from the fluid-cooled duct 40.

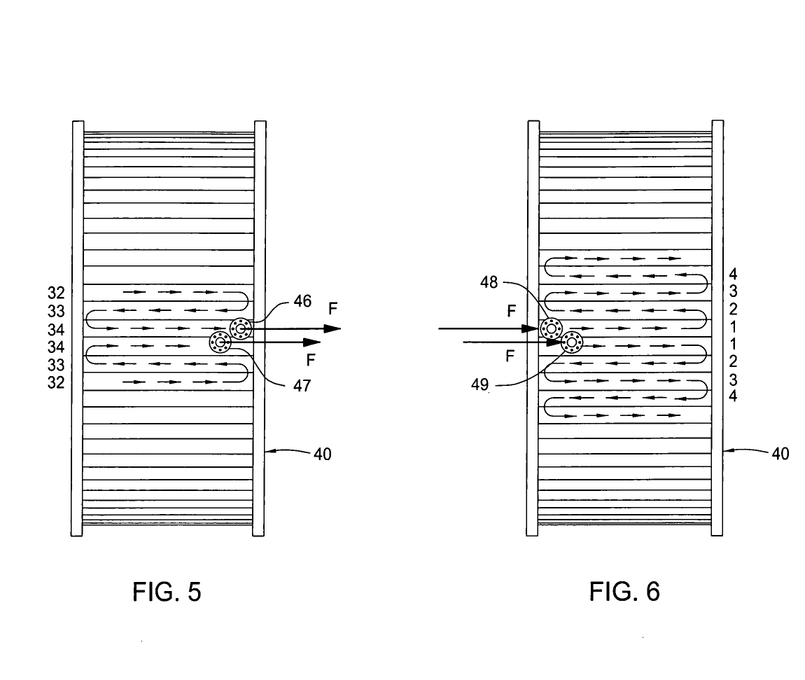

FIGS. 5-7A depict a first embodiment of the fluid-cooled duct 40. FIGS. 5 and 6 illustrate a side view of a portion of the fluid-cooled duct 40 having two fluid outlet ports 46, 47 therein for allowing fluid F flow out of the cooling fluid flow system (described in more detail below) used to cool the fluid-cooled duct 40 and a side view of a portion of the fluid-cooled duct 40 having two fluid inlet ports 48, 49 therein for allowing fluid F flow into the cooling fluid flow system, respectively. FIGS. 5 and 6 also illustrate exemplary fluid F flow patterns through the cooling fluid flow system.

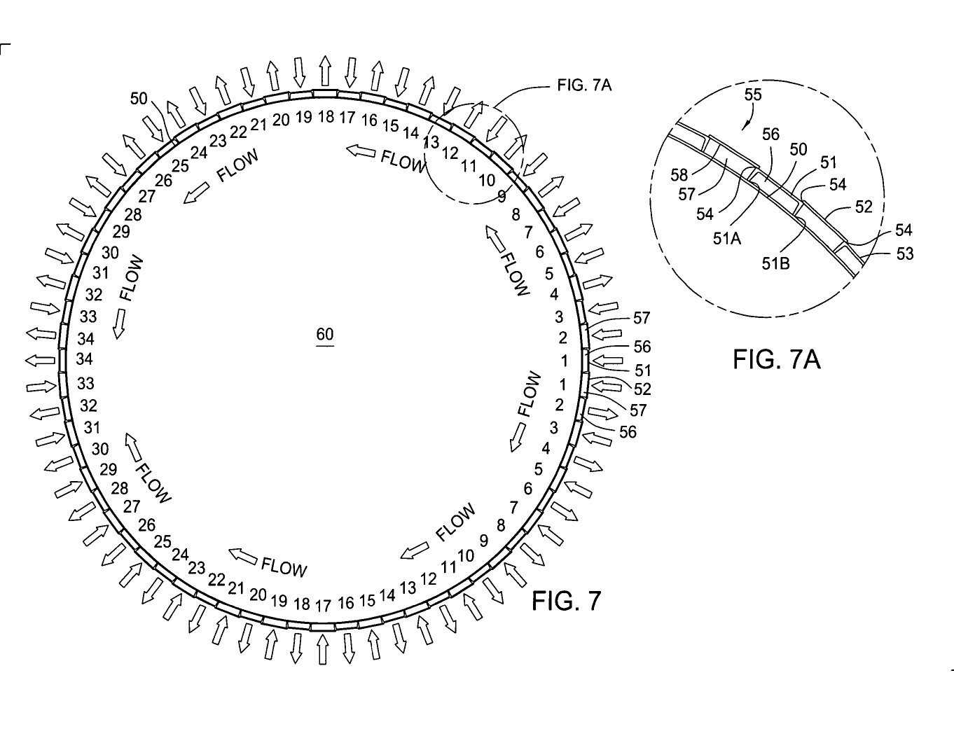

As illustrated in FIGS. 5-7A, particularly in FIGS. 7 and 7A, the fluid-cooled duct 40 includes an at least substantially continuous base material 50 through which the effluent E is flowable. The cross-sectional shape of the base material 50 may be, for example, generally rectangular, oval or circular (FIG. 7 shows a base material with a generally circular cross-section); however, it is contemplated that the base material 50 may have a cross-section of any shape capable of transporting effluent E therethrough.

The base material 50 is preferably smooth around its perimeter (both the inner surface forming the inner diameter and the inner surface forming the outer diameter) to permit at least substantially uninhibited fluid F flow around portions of the outer diameter of the base material 50 as well as at least substantially uninhibited effluent E flow through the inner diameter of the base material 50 (through a bore 60 through the duct 40 formed by the base material 50), as described below. Preferably, the base material 50 is constructed of a rolled material duct work, or is constructed of one or more rolled ducts or sheets (preferably one or more rolled metal ducts). Most preferably, the base material 50 is constructed from a sheet of channeled steel or another metal with similar physical properties which is known to those skilled in the art.

The base material 50 performs dual roles in the fluid-cooled duct system. While the effluent E only flows through the inner diameter of the base material 50 (through the bore 60 through the duct 40), the base material 50 also forms a portion of the fluid flow system 55 through which the cooling fluid F flows to cool the effluent E through heat transfer through the base material 50. Thus, the base material 50 acts as the barrier through which the temperature of the effluent E is cooled by the cooling fluid F flowing through the fluid flow system 55.

As shown in FIGS. 7 and 7A, the flow path for the cooling fluid F is formed by the cooperation of the outer diameter of the base material 50, one or more channels 51, and one or more connecting members or bars 52. The channels 51 are preferably U-shaped (but may instead be of any shape capable of connecting at each end to the outer diameter of the base material 50 while still allowing sufficient fluid F flow therethrough, for example C-shaped), while the bars 52 preferably are flat members constructed from flatbar (but may instead be of any shape capable of connecting to outer surfaces of adjacent channels 51 and still allowing sufficient fluid F flow therein, as described below). Preferably, although not necessarily, the channels 51 and bars 52 are made of steel or another metal or material having similar physical properties to allow cooling fluid flow therethrough.

As shown, the fluid flow system 55 is formed by operably connecting channels 51 to the base material 50 at intervals, for example by welding ends 51A, 51B of the channels 51 to spaced locations on an outer diameter of the base material 50. (It is understood that it is within the scope of the present invention that other portions of the channels 51 instead of or in addition to the ends 51A, 51B may be connected to the outer diameter of the base material 50.) Each bar 52 is then operatively connected to the outside 53 of adjacent channels 51 at locations 54. (In an alternate embodiment, the channels 51 and bars 52 are properly operatively connected to one another before connecting the ends 51A, 51B (or other portions) of the channels 51 to the outer diameter of the base material 50.) Fluid flow paths 56 are thus formed through each channel 51, as each flow path 56 is defined by an inside of the “U” of the channel 51 and the outer diameter of the base material 50. Additionally, alternating fluid flow paths 57 are defined by the outer diameter of the base material 50, the outer diameter of at least a portion of each adjacent channel 51, and an inside surface 58 of each bar 52.

In an alternate embodiment, the one or more channels 51 are disposed on the outer diameter of the base material 50 at least substantially adjacent to one another, and the bars 52 are either not present at all or the bars 52 are intermittently located between adjacent channels in any pattern.

Each channel 51 and bar 52 preferably extends at least substantially the entire length of the duct 40. In any event, the adjacent ends of the flow paths through channels 51 and the cooperating bar/channel flow paths are operatively connected to one another. For example, an elbow piece (not shown) may be utilized to provide a flow path to and from adjacent channels 51 and bars 52. Preferably, elbow pieces are used to connect each adjacent channel 51 and bar 52 to one another so that the fluid F can flow as depicted in FIGS. 5, 6, and 7, where fluid flow is at least substantially uninterrupted as it flows to and from adjacent channels 51 and bars 52.

It is notable that unlike the difficult-to-repair piping 31 typically utilized to flow the cooling water through the prior art water-cooled duct systems, the channels 51 and bars 52 are uniformly shaped and commonly obtainable parts, even capable of purchase at an ordinary hardware store. Therefore, if a leak develops in one or more channels 51 and/or bars 52, that channel 51 and/or bar 52 is easily replaced by removing the problematic channel and/or bar from a location and operatively connecting a new (or repaired) channel 51 and/or bar 52 at the location (if necessary, the length of the channel or bar is altered prior to its placement at the repair location, for example by cutting). Furthermore, unlike the piping 31 where the piping's inward-facing outer surface forms the flow path for the effluent E through the bore 1 of the duct 30 of the prior art and requires expense and complication to repair damaged piping 31, the flat, smooth inner surface of the base material 50 which forms the bore 60 for the flow of effluent E through the fluid-cooled duct 40 is capable of patching at damaged locations by merely connecting (e.g., by welding) a piece of base material, preferably channeled metal, to an inner diameter of the fluid-cooled duct 40. Accordingly, in this manner, repair of the fluid-cooled duct 40 of embodiments of the present invention is facilitated, thereby reducing down-time and saving down-time costs as well as repair costs.

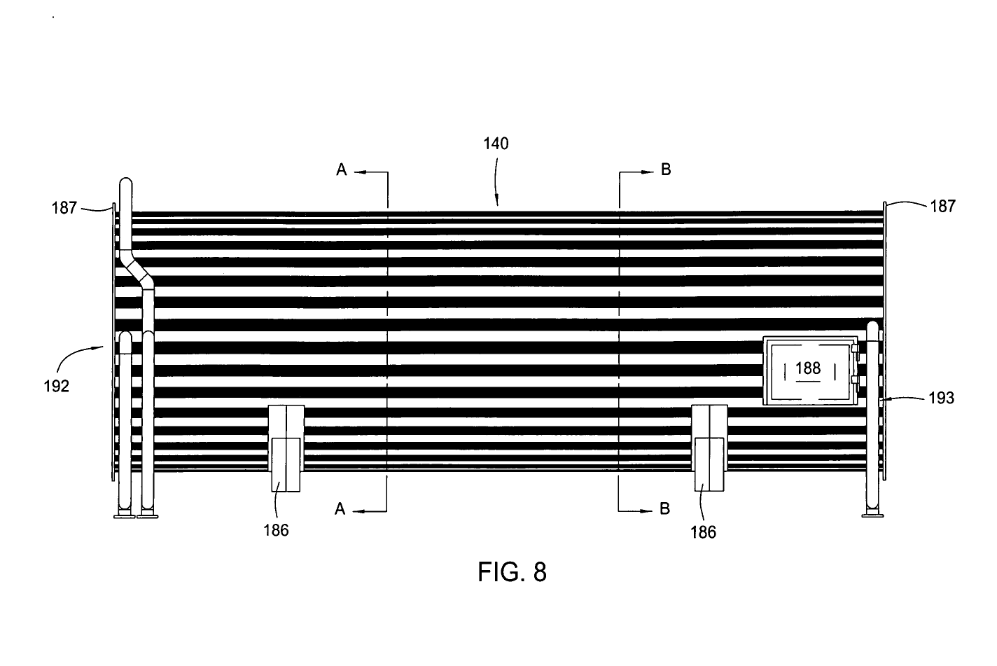

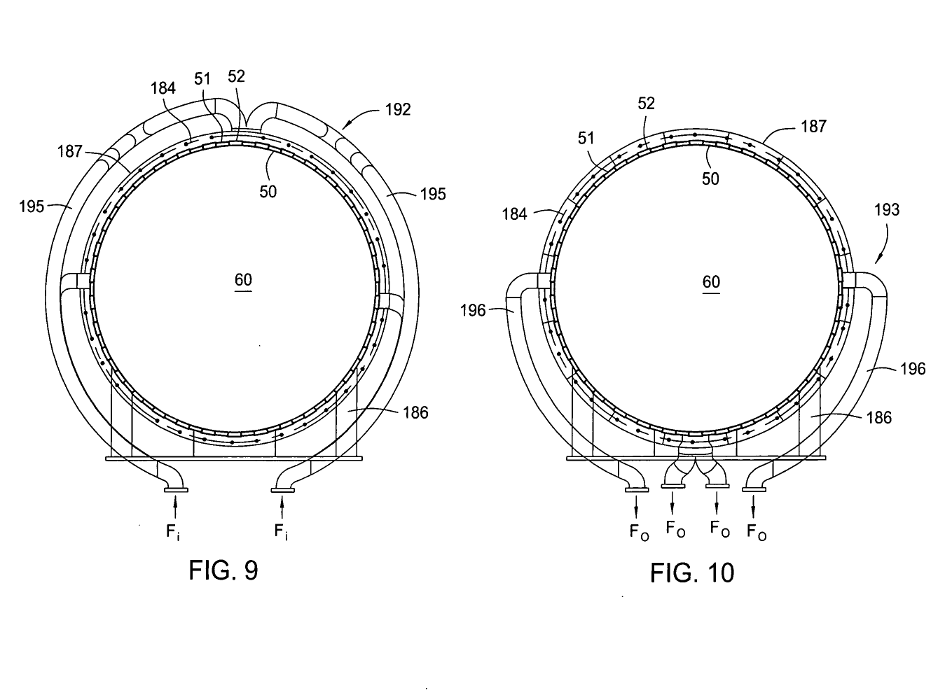

FIGS. 8-10 show an alternate embodiment of a fluid-cooled duct 140. FIG. 8 is a side view of the fluid-cooled duct 140, while FIG. 9 is a cross-sectional view through the duct 140 at the point designed by line A-A of FIG. 8 viewed in the direction of the arrows and FIG. 10 is a cross-sectional view through the duct 140 at the point designated by line B-B of FIG. 8 viewed in the direction of the arrows. The fluid-cooled duct 140 is substantially the same in structure and operation to the fluid-cooled duct 40; therefore, like parts of the fluid-cooled duct 140 are labeled with like numbers to the fluid-cooled duct 40.

The primary difference between fluid-cooled duct 140 and fluid-cooled duct 40 is that fluid-cooled duct 140 includes multiple fluid inlet Fᵢ locations and multiple fluid outlet Fₒ locations. FIGS. 8-10 illustrate the fluid delivery system 192 and fluid exit system 193. The fluid delivery system 192 preferably includes one or more tubulars 195 for introducing fluid (e.g., water) into the fluid-cooled duct system for cooling the effluent E, while the fluid exit system 193 preferably includes one or more tubulars 196 for carrying fluid out of the cooling fluid flow system for re-cooling (and possibly re-pressurizing) of the fluid prior to its recycling back into the fluid-cooled duct system via the fluid delivery system 192. The one or more tubulars may include piping, tubing, conduit(s) or any other material capable of carrying a fluid through its bore, including material having any cross-sectional shape known to those skilled in the art (e.g., circular, rectangular, etc.) and constructed of any material known to those skilled in the art (e.g., any type of metal such as steel).

The quantity and size (e.g., diameter) of inlet and outlet tubulars 195, 196 for flowing and transporting the fluid F into and out of the fluid flow system, as well as the quantity and size of the channels 51 and bars 52, are preferably tailored to the application and to the size (length and diameter) of the base material 50 and bore 60 as well as other system parameters such as effluent E temperature, desired temperature decrease of the effluent E upon its exit from the bore 60, and length of the entire duct system including any additional fluid-cooled ducts operatively connected to the fluid-cooled duct 140. For example, the inner diameters of the inlet and outlet pipes may be approximately 4 inches. Additionally, the wall thicknesses of the inlet and outlet pipes, as well as the wall thicknesses of the base material 50, channels 51, and bars 52, are preferably optimized depending upon the application, system parameters, and desired output. If it is desired to dissipate heat more quickly from the effluent E into the fluid F, the inlet and/or outlet pipe, base material 50, channels 51, and/or bars 52 may be made thinner to allow this facilitated heat dissipation; however, the thinner the material, the more likely the material is to melt due to the heat flowing therethrough. These factors may prove important to keep in mind when designing and optimizing parameters of the fluid-cooled duct and the duct system.

The inlet and outlet ports/pipes are operatively connected to a portion of the channels 51 or bars 52, for example by removing the portion of the channels 51 and/or bars 52 and welding each pipe/port into each removed portion, threading each pipe/port into a corresponding threaded connection in each removed portion, or connecting each pipe/port to each removed portion, for example by using one or more fastening members such as bolts or screws.

In the embodiment shown in FIGS. 8-10, one or more flanges 187 are operatively connected to an outer diameter of the channel/bar arrangement at each end of the fluid-cooled duct 140. In one connection method, the flanges 187 may include one or more holes 184 therethrough. To connect the fluid-cooled duct 140 to another fluid-cooled duct (not shown), to a non-fluid-cooled duct, or to another portion of the steel mill system, the adjacent duct or the other portion of the steel mill system preferably includes a corresponding flange (not shown) at its end which is aligned with the flange 187 of the fluid-cooled duct 140. The holes 184 are aligned with corresponding holes in the adjacent duct or other component of the steel mill system, and one or more bolts, screws, or other fastening members are used to connect the adjacent components to one another so that the effluent E may flow to and from the bore 60 of the fluid-cooled duct 140 without exiting the steel mill system.

FIG. 8 illustrates an access point into the fluid-cooled duct 140, shown as an access hatch or door 188, which may optionally be included in the system to allow inspection of the system and access into the system by the opening of the access hatch or door 188. Also optional are the saddles 186 shown in FIG. 8. One or more saddles 186 or another type of support device for supporting the fluid-cooled duct 140 on the floor or other surface may be spaced along the length of the fluid-cooled duct 140, as desired.

Operation of an embodiment of the fluid-cooled duct system proceeds as follows. To begin fluid F flow through the fluid transport system (i.e., fluid flow system), fluid F is cooled (if necessary) to the desired temperature using cooling equipment (not shown) which is known to those skilled in the art (the fluid F may also optionally be pressurized by pressurizing equipment, and the cooling and pressurizing function may optionally be performed by the same piece of equipment). The equipment may be operatively attached to the fluid transport system. The cooled fluid F is then introduced into the fluid inlet port(s) 48, 49 or Fᵢ, for example by one or more hoses operatively connected to the inlet port(s) (which may include using fastening members or threadedly connecting the hose(s) to the fluid inlet port(s) 48, 49 or Fᵢ). The one or more hoses may be operatively connected to a holding tank (not shown) for at least temporarily storing (and possibly cooling) the fluid F, as well as to the cooling equipment. The one or more hoses (or other hoses connected to these hoses) may be operatively connected at their other ends to the fluid outlet port(s) 46, 47 or Fₒ, whether or not the holding tank or cooling equipment is operatively connected between the connections of the hose(s) to the fluid inlet(s) and fluid outlet(s).

Referring in particular to FIGS. 5, 6, 7, and 7A, the fluid F introduced into the inlet port 48 flows into the first fluid flow path 56 through the channel 51, designated by the upper position 1 in FIGS. 6 and 7. The fluid F then flows through the length of the fluid flow path 56 in position 1 until it reaches the connection point between the fluid flow path 56 and the fluid flow path 57. The fluid F flows around this connection point, as shown in FIG. 6, and then flows into the fluid flow path 57 at designated by position 2 located above position 1. The fluid F then travels the length of the fluid flow path 57 in position 2 (in the opposite direction from the previous fluid flow through the fluid flow path 56 in position 1) until it reaches the connection point between the fluid flow path 57 in position 2 and the fluid flow path 56 in position 3 (above position 2), where the fluid travels around the connection point as shown in FIG. 6 to flow through the length of the fluid flow path 56 in position 3 (in the opposite direction of fluid flow through previous position 2). The fluid F continues in this same manner (as shown in FIG. 7, the fluid travels clockwise around the outer diameter of the duct 40 from position 1 to position 34) through the fluid flow system (partially shown in FIGS. 6 and 7) until it reaches the upper position 34, which represents the fluid outlet port 46 in the illustrative embodiment (see FIGS. 5 and 7). The fluid F exits the fluid flow system through the fluid outlet port 46. At this point in the operation, the fluid F may optionally be recycled back into the fluid flow system via inlet port 48 (see FIG. 6) after optionally being cooled and/or pressurized to travel the same path through the fluid flow system. Preferably, the fluid F continuously flows around the fluid flow system and is continually cooled and/or pressurized during fluid flow, more preferably in conjunction with the operation of sensing and controlling equipment (which may be computerized) for measuring parameters and implementing changes in parameters as necessary to maintain an optimal cooling system.

The lower half of the fluid flow system, as depicted in FIGS. 5, 6, 7, and 7A as clockwise fluid flow around the lower half of the perimeter of the base material 50 of the duct 40 (see specifically FIGS. 5-7), operates in much the same manner as the upper half of the fluid flow system described above (although the fluid flow F is in the opposite direction, counterclockwise around the bore 60, for the upper half of the fluid flow system). In the lower half of the fluid flow system in the shown embodiments, fluid F enters the fluid flow path around the outside of the duct 40 through the inlet port 49. The fluid F then flows from the inlet port 49 into the fluid flow path 57 at lower position 1 shown in FIGS. 6 and 7. As shown in FIG. 6, the fluid F travels the length of the fluid flow path 57 at position 1, travels around the connection point between the fluid flow path 57 at position 1 and fluid flow path 56 at lower position 2, then enters and flows through fluid flow path 56 at position 2 in the opposite direction of fluid flow through fluid flow path 57 through position 1. The fluid F progresses counterclockwise around the outer diameter of the duct 40 in alternating directions as depicted in FIGS. 5-7 until it reaches the last position 34 (see FIGS. 5 and 7). Upon reaches the end of the fluid flow path through the last position 34, the fluid F exits from the fluid flow system through the fluid outlet port 47. This fluid F may optionally be recycled into this half of the fluid flow system, and my optionally be cooled and/or pressurized before its reentry into the fluid flow system.

While fluid F is traveling through the fluid flow system, the fluid F is directly contacting an outer surface of the base material 50. The effluent E flows through the bore 60 in the base material 50 and is in direct contact with the inner surface of the base material 50. The heat from the effluent E is transferred through the base material 50 into the cooling fluid F as the fluid F travels through the fluid flow system, thereby lowering the temperature of the effluent E to prevent melting of the base material 50 or any other portion of the fluid-cooled duct 40.

Upon failure of a portion of the base material 50, another easily-accessible portion of base material is operatively connected to the failed portion of the base material 50, e.g. by welding, so that down-time is minimized for repair of the system. Upon failure of any portion of the fluid flow system making up the fluid flow paths 56, 57 (i.e. the bars 52 or channels 51), the failed bar or channel is easily removed from the system from its location, and a replacement bar or channel is easily operatively connected to that location, for example by welding. Again, down-time for repair of the system is minimized. Down-time is minimized also in both of these situations because specialty pieces do not need to be formulated, shaped, and specially (and very precisely) installed (such as the portion of the pipe described in relation to the prior art system) in order to repair the system.

The fluid F flowed through the fluid cooling system of the fluid-cooled duct 40 is preferably water, but may instead be any fluid known by those skilled in the art capable of cooling the particular effluent E exiting the furnace 39. The fluid F is preferably pressurized and cooled through a system known to those skilled in the art prior to its entrance through the inlets 48, 49 into the cooling fluid flow system and circuitry.

Although the duct formed from the base material 50 is shown having a generally circular cross-section, it is understood that the base material 50 (e.g., the rolled duct) may be formed into any shape capable of hosting effluent flow E therethrough (any shape through which a bore 60 is formed), including for example a square, round, rectangular, or oblong shape. Furthermore, even though the embodiments above are described in relation to half of the system fluid traveling one way around the duct 40 (counterclockwise) and half of the system fluid traveling the opposite way around the duct 40 (clockwise), it is within the scope of embodiments of the present invention that the fluids may travel in the same directions from different starting points, and it is also within the scope of embodiments that the separated fluid flow systems (e.g., each half being a separate fluid flow system) may make up different fractions of the outer diameter of the base material 50 (e.g., ¾ and ¼, ⅓ and ⅔, etc.). In another alternate embodiment, only one fluid inlet and one fluid outlet exists, and the fluid travels in the same direction all the way around the diameter of the base material 50 between the fluid inlet and the fluid outlet.

In any of the embodiments described above, the following dimensions represent a preferred embodiment, although the dimensions are not limiting to the scope of embodiments and are provided merely as examples. Any dimensions of the components of the above-described embodiments are contemplated as within the scope of embodiments of the present invention. As an example, in the embodiment shown in FIGS. 5-7A, the base material forming the duct has an inner diameter of approximately 10 inches, and the base material is ¼-inch plate (rolled), A516 grade 70. Each channel may be a standard C6×8.2 channel (×36), and each bar may be standard 6 inches×0.75-inch flatbar. The distance between connection points (welds) where the bar is welded to adjacent channels may be approximately 5.5 inches (when connecting the same bar to multiple adjacent channels). The thickness of each of the flanges at each end of the fluid-cooled duct may measure approximately 0.75 inch, the flanges may possess an inner diameter of approximately 10 feet and an outer diameter of approximately 11 feet, and the flanges may protrude from the outer diameter of the base material duct approximately 3 9/16 inches. The distance of the flanges at each end of the fluid-cooled duct from one another may be 6-foot 2¼ inches as measured from their inside-facing ends (the ends directly connected to the base material; therefore, the base material length is approximately the same dimension) and may be 6-foot 3¾ inches as measured from their outward facing ends. The bolt holes of the flanges at the ends of the duct may be field fit. The inlet and outlet pipes are preferably formed of 4-inch schedule 40 pipe and each include on their ends a 125-pound pipe flange, where the pipe flange has an outer diameter of approximately 9 inches, a thickness of approximately 15/16 inches, a bolt circle of approximately 7.5 inches, and approximately 0.75-inch diameter bolt holes (approximately 4 are needed). Approximately 8 bolts may be usable in the pipe flange bolt holes. When measuring from the center of the bore of the inlet pipe 48 or the inlet pipe 49 to the inward-facing end of the closest flange disposed at the end of the fluid-cooled duct, the distance may be approximately 6 inches and approximately 1-foot 2.5 inches, respectively. When measuring from the center of the bore of the outlet pipe 46 to the inward-facing end of the closest flange disposed at the end of the fluid-cooled duct, the distance may also be approximately 6 inches and approximately 1-foot 2.5 inches, respectively. When measuring from the outward-facing end surface of each pipe flange to the outer diameter of the base material duct, the distance may be approximately 4.5 inches.

Also as an example of a preferred embodiment and in no way limiting to the scope of embodiments of the present invention, the following dimensions are in reference to the embodiment shown in FIGS. 8-10. The flanges at each end of the base material may be 6-inch×¾-inch flanges, may have an outer diameter of approximately 134¾ inches, may possess approximately 36 holes therein having approximately 1-inch diameters (which may be equally spaced on 5-foot 5⅞-inch BC and may be approximately 11 inches from one another as measured from the centers of the holes), may be approximately 32-feet 8¾ inches from one another as measured from their inward-facing surfaces (which would also be the approximate length of the base material duct), and may be approximately 32-feet 10¼-inches from one another as measured from the outward-facing end surfaces of the flanges. The distance from the inward-facing surfaces of the flanges to the mid-point of the closest saddle 186 to each flange may be approximately 89 3/16 inches, and the distance between the mid-points of the saddles 186 may be approximately 213⅛ inches. The distances from the closest surface of the access hatch/door 188 to the inward-facing surface of the closest flange (and therefore the outer end of the base material) may be approximately 12.5 inches. Each channel may be a standard C6×13 channel, and each bar may be standard 5-inch×¼-inch flatbar. There may be a total of approximately 36 channels and approximately 35 flatbars. The inlet and outlet pipes may be constructed from 6-inch pipe. The bore of the duct 60 may have a radius of approximately 122¾ inches.

While the foregoing is directed to embodiments of the present invention, other and further embodiments of the invention may be devised without departing from the basic scope thereof, and the scope thereof is determined by the claims that follow.

1. A fluid-cooled duct for transporting effluent from a steel mill furnace, comprising:
a duct comprising a base material having a bore therethrough for transporting the effluent; and
a fluid flow system disposed on the outer surface of the base material, comprising:
a channel member operatively connected to an outer surface of the base material at first and second locations on the outer surface, and
a bar member operatively connected to an outer surface of the channel member, wherein:
a first fluid flow path is defined by an inner surface of the channel member and an outer surface of the base material, and
a second fluid flow path is at least partially defined by an outer surface of the channel member, an inner surface of the bar member, and an outer surface of the base material,
wherein fluid is capable of flow through the first and second fluid flow paths to lower the temperature of the effluent via heat transfer through a wall of the base material.

2. The fluid-cooled duct of claim 1, wherein the fluid is flowable in one direction through the first fluid flow path and in an opposite direction through the second fluid flow path.

3. The fluid-cooled duct of claim 1, wherein the fluid comprises water.

4. The fluid-cooled duct of claim 1, wherein the base material comprises rolled duct work.

5. The fluid-cooled duct of claim 1, wherein an inner surface of the base material forming the bore for the effluent provides a smooth surface for at least substantially uninhibited effluent flow therethrough.

6. The fluid-cooled duct of claim 1, wherein:
the channel member comprises a generally U-shaped channel;
a first end of the U-shaped channel is operatively attached to the first location on the outer surface of the base material; and
a second end of the U-shaped channel is operatively attached to the second location.

7. The fluid-cooled duct of claim 1, wherein the bar member comprises flatbar.

8. The fluid-cooled duct of claim 1, further comprising an additional channel member, wherein the additional channel member is operatively connected to the outer surface of the base material at third and fourth locations on the base material.

9. The fluid-cooled duct of claim 8, wherein:
the bar member is operatively connected to the channel member and to the additional channel member;
the second fluid flow path is defined by the outer surface of the channel member, the inner surface of the bar member, the outer surface of the base material, and an outer surface of the additional channel member; and
a third fluid flow path is defined by an inner surface of the channel member and the outer surface of the base material between the third and fourth locations.

10. The fluid-cooled duct of claim 1, further comprising:
at least one inlet port disposed in either the channel member or the bar member for delivery of the fluid into the fluid flow system; and
at least one outlet port disposed in the fluid flow system to allow fluid exit from the fluid flow system.

11. The fluid-cooled duct of claim 1, wherein the channel member and bar member extend generally parallel to one another for at least substantially the entire length of the base material.

12. The fluid-cooled duct of claim 11, wherein the first and second fluid flow paths are generally parallel to the direction of effluent flow through the bore of the base material.

13. A method of cooling effluent flowing through a fluid-cooled duct from a steel mill furnace, comprising:
providing a fluid-cooled duct comprising:
a base material shaped to provide a bore for transporting the effluent therethrough, and
one or more channel members at least partially defining a first fluid flow path around an outer surface of the base material and one or more bar members at least partially defining a second fluid flow path around the outer surface of the base material;
introducing a fluid into the first fluid flow path;
flowing the fluid from the first fluid flow path into the second fluid flow path; and
allowing heat transfer from the effluent to the fluid via the base material.

14. The method of claim 13, further comprising:
allowing the fluid to exit from the fluid flow system; and
cooling the fluid for recycling into the fluid flow system.

15. The method of claim 13, further comprising repairing a portion of the fluid-cooled duct by patching the base material, one or more channel members, or one or more bar members with standard base material patches, channel members, or bar members.

16. A method of forming a fluid-cooled duct, comprising:
providing a base material shaped to provide a longitudinal bore therethrough, a channel member, and a bar member;
operatively connecting at least two underside portions of the channel member to an outer surface of the base material at first and second locations;
operatively connecting the bar member to an outer surface of the channel member; and
forming a first fluid flow path defined by the channel and base material and a second fluid flow path at least partially defined by the bar member, base material, and an outer surface of the channel.

17. The method of claim 16, wherein the channel is generally U-shaped.

18. The method of claim 16, wherein the channel member and bar member are operatively connected to the base material along at least substantially their entire lengths, and wherein the channel member and bar member extend generally parallel to a direction of flow of the effluent through the bore.

19. The method of claim 18, further comprising connecting the first and second fluid flow paths to one another to allow fluid flow from the first fluid flow path to the second fluid flow path.

20. The method of claim 19, further comprising flowing fluid in one direction through the first fluid flow path and flowing the fluid in an opposite direction through the second fluid flow path.
